(19) United States
(12) Patent Application Publication
(10) Pub. No.: US 2025/0080351 A1
(43) Pub. Date: Mar. 6, 2025

(54) SYSTEM AND METHOD FOR A TOKEN GATEWAY ENVIRONMENT

(71) Applicant: Experian Information Solutions, Inc., Costa Mesa, CA (US)

(72) Inventors: Alpa Modi Jain, Laguna Niguel, CA (US); Praveen Kumar Soni, Costa Mesa, CA (US); Frederic Vander Elst, London (GB)

(21) Appl. No.: 18/890,666

(22) Filed: Sep. 19, 2024

Related U.S. Application Data
(63) Continuation of application No. 18/153,587, filed on Jan. 12, 2023, now Pat. No. 12,132,837.
Application No. 18/153,587 is a continuation of application No. 17/123,568, filed on Dec. 16, 2020, now Pat. No. 11,588,639.
Application No. 17/123,568 is a continuation of application No. 16/051,339, filed on Jul. 31, 2018, now Pat. No. 10,911,234.
(60) Provisional application No. 62/688,887, filed on Jun. 22, 2018.

(51) Int. Cl. H04L 9/32; H04L 9/08; H04L 9/40

(52) U.S. Cl. CPC H04L 9/3213; H04L 9/0894; H04L 9/3247; H04L 63/0428; H04L 63/08; H04L 63/10; H04L 63/0807; H04L 63/0815

(57) ABSTRACT

Embodiments include a method for providing tokens which includes: receiving from a user system an encrypted data packet including user credentials and a request for an authentication token to access protected resources; extracting the user's security information; transmitting a data packet to a security and access management system, where the data packet includes the user's security information and a request for user validation; receiving, from the security and access management system, user validation and additional data; generating a thin token and a fat token; storing the thin token in association with the fat token; transmitting the thin token to the user system; receiving, from the user system, a request to access protected resources from a protected resource system, the request including the thin token; validating the received thin token; accessing the fat token associated with the thin token; and transmitting the fat token to the protected resource system.

### CROSS-REFERENCE TO RELATED APPLICATIONS

This application is a continuation of U.S. patent application Ser. No. 18/153,587 filed Jan. 12, 2023 and titled “SYSTEM AND METHOD FOR A TOKEN GATEWAY ENVIRONMENT,” which is a continuation of U.S. patent application Ser. No. 17/123,568 filed Dec. 16, 2020 and titled “SYSTEM AND METHOD FOR A TOKEN GATEWAY ENVIRONMENT,” which is a continuation of U.S. patent application Ser. No. 16/051,339, filed Jul. 31, 2018 and titled “SYSTEM AND METHOD FOR A TOKEN GATEWAY ENVIRONMENT,” which claims priority to U.S. Provisional Patent Application No. 62/688,887 filed on Jun. 22, 2018 and titled “SYSTEM AND METHOD FOR A TOKEN GATEWAY ENVIRONMENT.” The entire content of the above referenced applications are hereby expressly incorporated herein by reference in their entirety.

### BACKGROUND

The disclosure relates to a token gateway environment for providing more efficient and more secure authorization to parties accessing protected resources.

### SUMMARY OF THE DISCLOSURE

Various systems, methods, and devices are disclosed for providing a token gateway environment for providing authorization to parties accessing protected resources. The systems, methods, and devices of the disclosure each have several innovative aspects, no single one of which is solely responsible for the desirable attributes disclosed herein.

In one embodiment, a system for providing tokens to facilitate authentication and access to protected resources is disclosed. The system includes: a token gateway computing system in electronic communication with a third party user computing system; at least one security and access management computing system; a token management computing system; and a protected resource computing system, wherein the token gateway computing system is configured to: receive, from the third party user computing system, an encrypted data packet including user credentials of a third party user and a request for an authentication token to access one or more protected resources from the protected resource computing system; decrypt and parse the received encrypted data packet to extract the third party user's security information and to determine a type associated with each of the one or more protected resources requested; transmit an encrypted data packet to the at least one security and access management computing system based on the determined type, wherein the encrypted data packet includes the third party user's security information and a request for user validation; receive, from the at least one security and access management computing system, validation of the third party user, and private data; generate a thin token; generate a fat token using the private data; store the thin token in association with the fat token in the token management computing system; transmit the thin token to the third party user computing system; receive, from the third party user computing system, a request to access one or more protected resources from the protected resource computing system, the request comprising the thin token; validate the received thin token; access the fat token associated with the thin token in the token management computing system; and transmit the fat token to the protected resource computing system.

In another embodiment, a computer-implemented method for providing tokens to facilitate authentication and access to protected resources is disclosed. The computer-implemented method comprising, as implemented by one or more computing devices within a token gateway system configured with specific executable instructions receiving, from a third party user computing system, an encrypted data packet including user credentials of a third party user and a request for an authentication token to access one or more protected resources from a protected resource computing system; decrypting and parsing the received encrypted data packet to extract the third party user's security information and to determine a type associated with each of the one or more protected resources requested; transmitting an encrypted data packet to at least one security and access management computing system based on the determined type, wherein the encrypted data packet includes the third party user's security information and a request for user validation; receiving, from the at least one security and access management computing system, validation of the third party user, and private data; generating a thin token; generating a fat token using the private data; storing the thin token in association with the fat token in the token management computing system; transmitting the thin token to the third party user computing system; receiving, from the third party user computing system, a request to access one or more protected resources from the protected resource computing system, the request comprising the thin token; validating the received thin token; accessing the fat token associated with the thin token in a token management computing system; and transmitting the fat token to the protected resource computing system.

In a further embodiment, a non-transitory computer storage medium storing computer-executable instructions is disclosed. The computer-executable instructions, when executed by a processor, can cause the processor to at least: receive, from a third party user computing system, an encrypted data packet including user credentials of a third party user and a request for an authentication token to access one or more protected resources from a protected resource computing system; decrypt and parse the received encrypted data packet to extract the third party user's security information and to determine a type associated with each of the one or more protected resources requested; transmit an encrypted data packet to at least one security and access management computing system based on the determined type, wherein the encrypted data packet includes the third party user's security information and a request for user validation; receive, from the at least one security and access management computing system, validation of the third party user, and private data; generate a thin token; generate a fat token using the private data; store the thin token in association with the fat token in the token management computing system; transmit the thin token to the third party user computing system; receive, from the third party user computing system, a request to access one or more protected resources from the protected resource computing system, the request comprising the thin token; validate the received thin token; access the fat token associated with the thin token in a token management computing system; and transmit the fat token to the protected resource computing system.

### BRIEF DESCRIPTION OF DRAWINGS

The foregoing aspects and many of the attendant advantages of this disclosure will become more readily appreciated as the same become better understood by reference to the following detailed description, when taken in conjunction with the accompanying drawings. The accompanying drawings, which are incorporated in, and constitute a part of, this specification, illustrate embodiments of the disclosure.

Throughout the drawings, reference numbers are re-used to indicate correspondence between referenced elements. The drawings are provided to illustrate embodiments of the subject matter described herein and not to limit the scope thereof. Specific embodiments will be described with reference to the following drawings.

FIG. 1 is an overall system diagram depicting one embodiment of a token gateway environment.

FIG. 2 is a block diagram illustrating an embodiment of information flow within the token gateway environment.

FIG. 3 is a block diagram illustrating an embodiment of a process of initiating of token generation.

FIG. 4 is a block diagram illustrating an embodiment of a process for generating tokens.

FIG. 5 is a block diagram illustrating an embodiment of a process for accessing authorization to protected resources.

FIGS. 6A and 6B are block diagrams illustrating embodiments of token data structures.

FIGS. 7A, 7B, 7C and 7D are block diagrams illustrating embodiments of token headers.

FIG. 8 is a general system diagram illustrating an embodiment of a computing system.

### DESCRIPTION OF VARIOUS EMBODIMENTS

Embodiments of the disclosure will now be described with reference to the accompanying figures. The terminology used in the description presented herein is not intended to be interpreted in any limited or restrictive manner, simply because it is being utilized in conjunction with a detailed description of embodiments of the disclosure. Furthermore, embodiments of the disclosure may include several novel features, no single one of which is solely responsible for its desirable attributes or which is essential to practicing the embodiments of the disclosure herein described. For purposes of this disclosure, certain aspects, advantages, and novel features of various embodiments are described herein. It is to be understood that not necessarily all such advantages may be achieved in accordance with any particular embodiment. Thus, for example, those skilled in the art will recognize that one embodiment may be carried out in a manner that achieves one advantage or group of advantages as taught herein without necessarily achieving other advantages as may be taught or suggested herein.

### I. Overview

Features are described for embodiments of a token gateway environment. The token gateway environment helps to provide more efficient and/or more secure authorization to third parties accessing protected resources. In some embodiments, the environment enables trusted users of third parties to obtain limited access to protected resources such as, for example, secure data files. A requesting user of a third party may request a token to use for later accessing a protected resource. The requesting user sends an electronic request to the token gateway environment with his/her credentials, and then the token gateway environment validates the credentials with a security and access management environment using a standard open protocol such as OAuth 2.0. OAuth 2.0 is an authorization framework that enables applications to obtain limited access to user accounts. It works by delegating user authentication to the service that hosts the user account, and authorizing third-party applications to access the user account. OAuth 2.0 provides authorization flows for web, desktop applications and mobile devices.

If the requesting user's credentials are validated, two levels of tokens are generated by the token gateway environment. A first level token, referred to herein as a thin token, and a second level token, referred to herein as a fat token, are both generated. The thin token includes a minimal or smaller set of information associated with the requesting user that is used in secure authorization flows such as OAuth 2.0 to validate the access token or to provide information to decide whether to grant the requesting user access to the protected resource. The fat token includes additional details associated with the requesting user which may be internal and specific to the protected resources which may include information that cannot be shared with the third party for security or confidentiality reasons. Thus, the thin token is provided to the third party application, but the information in the fat token is not made available to the third party application.

When the requesting user then attempts to access the protected resources, the token gateway validates the user using the previously issued thin token and sends a token to the resource provider system to indicate that the user has been authenticated. However, rather than sending the standard thin token, the token gateway instead sends the corresponding fat token which includes the user's authentication information but also includes the internal and specific information retrieved from the security and access management system which may be too sensitive to have sent in any token directly to the third party user system. The standard secure authorization flow is not interrupted as a token is still sent to the resource provider system, but the thin token has been replaced with a more robust and data rich fat token.

### II. System

The environment may include a gateway system in communication with one or more third party environments requesting authorization to access one or more protected resources, where such resources may include, for example, resources including applications and reports on various backend servers or mainframe systems. The gateway system may also be in communication with one or more security and access management environments. The security and access management environments may include user profile repositories. The gateway system may also be in communication with a token management environment, including a token provider repository system. The token provider repository system may include various repositories for storing the different tokens of the token gateway system.

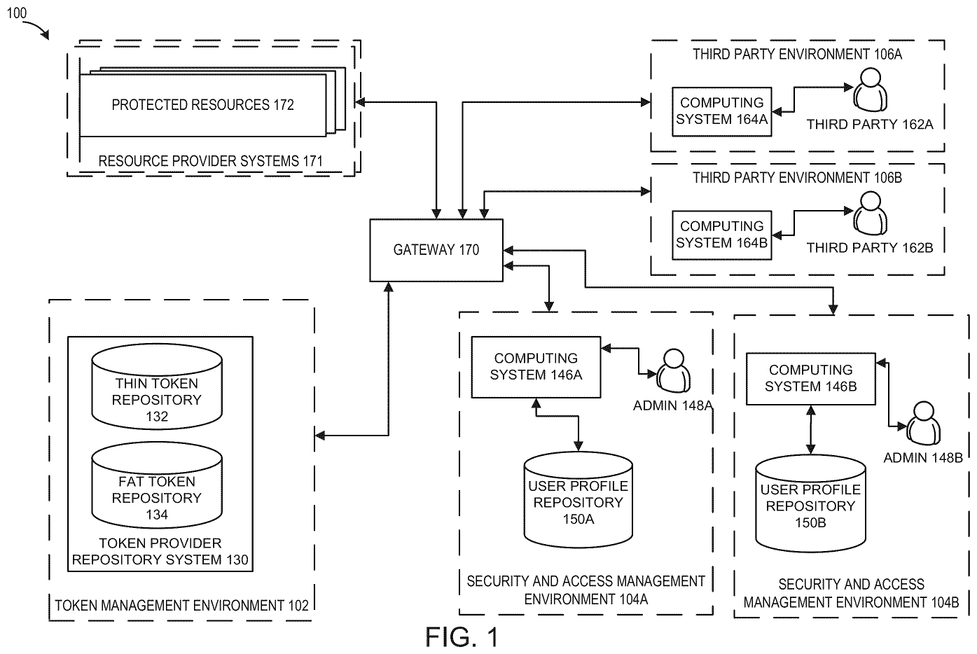

FIG. 1 is an overall system diagram depicting one embodiment of a token gateway environment 100 for providing more efficient and/or more secure authorization to parties accessing protected resources. The environment 100 shown in FIG. 1 includes third party environments 106A and 106B, gateway 170, security and access management environments 104A and 104B, token management environment 102, and resource provider systems 171 storing protected resources 172. In one embodiment, the systems may communicate via one or more networks, which may include one or more of a local area network, a wide area network, the Internet, or a cloud-computing network, implemented via a wired, wireless, or combination of wired and wireless communication links.

### A. Example Third Party Environments

The token gateway environment 100 shown in FIG. 1 includes third party environments 106A and 106B. The third party environments 106A and 106B respectively include users associated with third parties 162A and 162B, as well as the associated one or more computing systems 164A and 164B. The one or more computing systems may include computer devices whether they be a personal computer, server computer, laptop computer, or tablet; personal digital assistants (PDAs) such as a Palm-based device or Windows CE device; smart phones such as cellular phones; a wireless device such as a wireless email device or other device capable of communicating wireless with a computer network; or any other type of network device that may communicate over a network and process electronic transactions. While only two such computing systems are shown in FIG. 1, it is recognized that there could be several other computing systems in various embodiments.

Some examples of third parties include organizations that have requested products or services from one or more of the resource provider systems 171. The third party may be any entity using a computing system to request resources. For example third parties may include financial institutions, mortgage lenders, landlords, and the like, wishing to access protected credit information associated with one or more of consumers, borrowers, potential tenants, and the like. As another example, the third party organization may include medical providers, insurance companies, pharmacies, and the like, wishing to access protected health record data associated with patients. It is recognized that the token gateway environment 100 may provide validation of users to be able access a variety of protected resources.

The connection between a computing system and an online organization may be, for example, a connection between a client computer and a website server over a network. One or more servers may communicate with one or more client computers across a network. The network, for example, can include a private network, such as a LAN, or interconnections to the online organizations over a communications network, such as the Internet or World Wide Web or any other network that is capable of communicating digital data, such as a wireless or cellular network. Each computing system may connect to any online organization over the network using data protocols, such as HTTP, HTTPS and the like.

In one embodiment, the respective computing systems 164A and 164B communicate with the gateway 170 over a network to request authorization on behalf of the third parties 162A and 162B to access one or more of protected resources 172 on resource provider systems 171.

### B. Gateway

The token gateway environment 100 shown in FIG. 1 includes a gateway 170. The gateway 170 communicates with each of the third party environments 106A and 106B, security and access management environments 104A and 104B, token management environment 102, and the resource provider systems 171.

In some embodiments, the gateway 170 manages communications to enable third party applications 106A, 106B and the like to provide information to resource provider systems 171 to obtain limited access to protected resources 172. The illustrated gateway 170 communicates with security and access management platforms 104A, 104B and the like, facilitates a first level of authentication of the requesting users at third parties by generating a first token, and also generates a second token including additional information to provide information that can be used by the resource provider systems 171 to determine access to the protected resources 172.

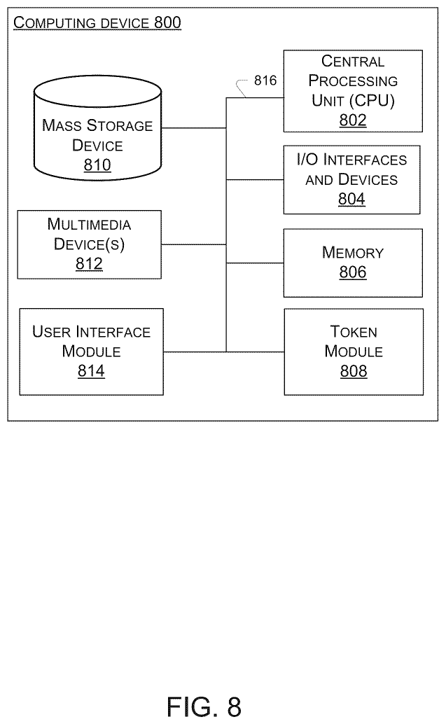

An example embodiment of a computing system for the gateway 170 is illustrated in FIG. 8, and described further below.

By providing the token generation, the gateway 170 acts as the perimeter security for the protected resources 172, authenticating the third party users through the appropriate systems, and allowing only authenticated third party users to move to the next level of potentially accessing the protected resources. Additionally, by separating the authentication and access tokens, proprietary information about the protected resources is not provided to any of the third parties.

### C. Example Security and Access Management Environments

The token gateway environment 100 shown in FIG. 1 includes security and access management environments 104A and 104B. The security and access management environments 104A and 104B respectively include administrators 148A and 148B, with associated computing systems 146A and 146B. The security and access management environments 104A and 104B also respectively include user profile repositories 150A and 150B. While only two such environments are shown in FIG. 1, it is recognized that there could be several others in various embodiments.

Some example security and access management environments 104A and 104B include identity and access management platforms such as for example Okta, Centify, Microsoft Azure, RSA SecurID, OneLogin, LDAP, and the like.

Each of the illustrated security and access management environments also include repositories a user profile repository 132 or 134. The user profile repository includes a data store configured to store information regarding user information and associated permissions for users associated with third parties and which can be used for accessing various protected resources. The third parties may be organizations or groups, and users may be associated with such organizations and groups. The user profile repository may also include additional information about the user such as, for example, which products he/she may have access to, what levels of access, or about the systems providing the products, such as, for example, secure IP information, security information, and the like.

While one database is included in each of the security and access management environments of the embodiment of FIG. 1, it is recognized that one or more of the databases may be combined, divided, and/or deleted. In addition, subsets of data from one database may be stored in another database as a duplicate copy or as the sole copy. Further, portions or all of one or more of the databases may be stored in a cloud, remote from the security and access management environments 104A or 104B, and/or stored in a distributed system.

When a user at a third party 162A or 162B requests authentication and access to a protected resource 172 from the gateway 170, the gateway 170 communicates with the appropriate one or more of the security and access management environments 104A, 104B, depending on the service that hosts the appropriate account for the third party user and the type of protected resource requested, to delegate the user authentication to the appropriate platform. The appropriate security and access management environments 104A, 104B then utilize the respective user profile repositories 150A, 150B to authenticate the third party requesting user.

### D. Token Management Environment

The token gateway environment 100 shown in FIG. 1 includes a token management environment 102. The token management environment 102 includes a token provider repository system 130, which includes one or more of thin token repository 132 and fat token repository 134. Although there are two repositories illustrated in FIG. 1, in various embodiments, the thin token repository 132 and fat token repository 134 may be the same repository, such as a single cache.

Each of the token repositories 132 and 134 includes a data store configured to store a local copy of the tokens. In one embodiment, the thin and fat tokens may be stored in a key-value cache scheme, where the thin token may represent the key, and the fat token may represent the associated value, and only the key is provided to the third party user after authentication, by providing the thin token. In some embodiments, the thin token may be associated with two or more fat tokens.

While two separate databases are included in the embodiment of FIG. 1, it is recognized that one or more of the databases may be combined, divided, and/or deleted. In addition, subsets of data from one database may be stored in another database as a duplicate copy or as the sole copy. Further, portions or all of one or more of the databases may be stored in a cloud, stored remote from the gateway 170, and/or stored in a distributed system. The

The token management environment may have modules for generating tokens, revoking access, deleting and/or flushing tokens, and so forth.

### E. Resource Provider Systems

The token gateway environment 100 shown in FIG. 1 includes resource provider systems 171 controlling protected resources 172. Some example resource provider systems 171 include for example back-end servers and/or mainframe systems of various data provider entities, such as for example, providers of credit data or credit reports, or repositories for storing health data.

### III. Example Information Flow

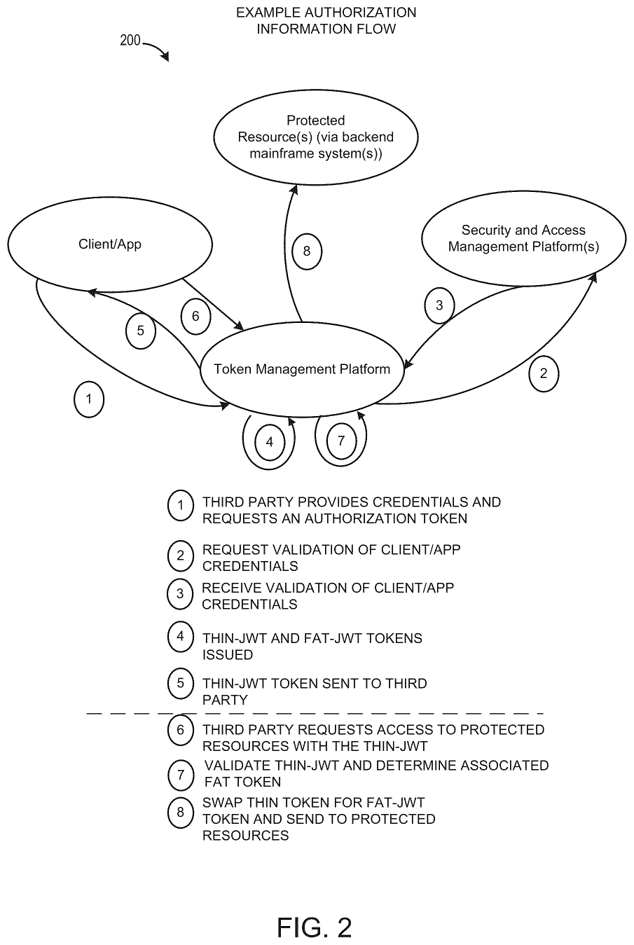

As described with reference to FIG. 1, the token gateway environment 100 can receive a request from a third party computing system 164A or 164B, and generate a thin token and a fat token to facilitate authentication of the requesting user from a third party to access one or more of the protected resources 172 on resource provider systems 171. FIG. 2 illustrates an example embodiment of information flow within the token gateway environment. The example data flow diagram 200 can involve one or more third party environments 106A or 106B, a gateway 170, a token management environment 102, and one or more security access management environments 104A or 104B.

At (1), a requesting user from a third party provides credentials and requests an authorization token to be used to access one or more protected resources. One or more third party computing systems can send a request to the gateway to obtain a token to get validation to access one or more of the protected resources. The request can include the requesting user's security information such as, for example, one or more of the user's username and password on one or more security and access management environments, the user's email addresses (for example, “username1@email.com” and “username2@anotheremail.com”), zip codes associated with the user's addresses (for example, the user's address in the past 2 years), the user's phone numbers (for example, the user's work phone and home phone numbers), and the like. The request may be in an XML format, although other formats such as, for example, txt or HTML are also possible. The gateway 170 can parse the request to extract the user's security information.

At (2), the gateway can communicate the request to one or more security and access management environment(s) for authenticating the requesting user based on the user's security information, and based on the type of protected resources for which access is requested. The appropriate security and access management environment(s) then verify the third party user's credentials. If the credentials are validated, validation is confirmed with the gateway, and the flow moves to (3). However, if the credentials are not validated, then the flow is interrupted.

If the credentials are validated by one or more of the security and access management platform(s), then, at (3), the gateway receives the validation.

At (4), the gateway then generates two tokens—a thin token and a fat token and stores them in a memory, such as for example a cache. The structure of both tokens may be based on JavaScript Object Notation (“JSON”) Web Token (“JWT”) and OAuth 2.0 authorization standards, but it is recognized that other structures and standards may be used.

JSON is a text format that is completely language independent but uses conventions that are similar to the C-family of languages, including C, C++, C #, Java, JavaScript, Perl, Python, and many others. JSON is built on two structures: (1) a collection of name/value pairs. In various languages, this is realized as an object, record, struct, dictionary, hash table, keyed list, or associative array, and (2) an ordered list of values. It makes sense that a data format that is interchangeable with programming languages also be based on these structures. In JSON: An object is an unordered set of name/value pairs and begins with { (left brace) and ends with } (right brace). Each name is followed by : (colon) and the name/value pairs are separated by , (comma). A value can be a string in double quotes, or a number, or true or false or null, or an object or an array. These structures can be nested. A string is a sequence of zero or more Unicode characters, wrapped in double quotes, using backslash escapes. A character is represented as a single character string. A number is very much like a C or Java number, except that the octal and hexadecimal formats are not used. Whitespace can be inserted between any pair of tokens.

OAuth 2.0 is an open protocol to allow secure authorization in a simple and standard method from web, mobile and desktop applications.

Both of the tokens may be encrypted. The thin token may be used as a key to the cache, whereas the fat token may be regarded as the data structure in the cache. In some embodiments, the thin token may be associated with one or more fat tokens. In some embodiments, the information stored in the thin token may include the minimal or smaller set of information required by the third party to validate the user's access to one or more of the protected resources. The fat token may store details internal to the protected resources, including, for example, user information, IP restriction, time of day values, product information, mainframe details, and the like. In some embodiments, a fat token may include one or more separate payloads for details obtained from one or more security and access management platforms. In other embodiments, a separate fat token may be created for capturing the details obtained from each of the security and access management platforms.

At (5), the gateway provides the thin token to the third party requester. This thin token may act as the equivalent of validation of the requested to then access one or more of the protected resources.

At (6), with a valid thin token, the requesting user at the third party can make a request to access one or more of the protected resources. The request may immediately follow the authorization request, or it may be some time after the authorization request. The access request is received by the gateway.

At (7), the gateway validates the thin token received, and, based on the validated thin token, accesses the associated fat token. As described above, the thin token may be regarded as the key which points to the appropriate location in the cache where the associated fat token is stored. The gateway may then retrieve the fat token for the requesting user and the protected resource requested.

At (8), the gateway swaps the thin token received from the third party for the fat token retrieved from the repository, and sends the fat token to the requested resource provider system 171 to confirm that the requesting user is authenticated such as via an API call. This way, the third party never receives additional information regarding the protected resources which may include details on specific IP address or mainframe details used by the resource provider system, or other sensitive or confidential information. Also, the resource provider system 171 does not need to communicate with the security and access management platforms again following initial authentication.

### IV. Gateway Environment Processes

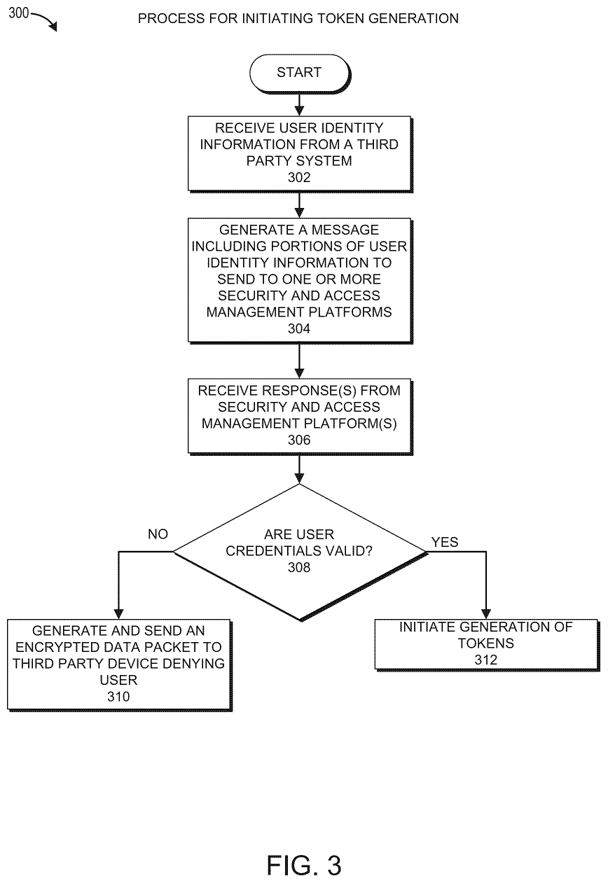

FIGS. 3, 4, and 5 are flowcharts illustrating various embodiments of processes that execute within the token gateway environment. In some embodiments, the processes are performed by the gateway 170 and/or other components of the token gateway environment 100. However, it is recognized that other components of other systems (not shown) may perform one or more of the processes. For ease of explanation, the following describes the services as performed by the gateway 170. The example scenarios are intended to illustrate, but not to limit, various aspects of the computing environment. In some embodiments, the processes can vary from the illustrated flowcharts, with some blocks omitted and other added.

### A. Token Generation Initiation Process

FIG. 3 is a block diagram illustrating an embodiment of a process of initiation of token generation.

In block 302, the gateway receives user identity information from a third party system. User identity information may include security information, for example, one or more of the user's username and password on one or more security and access management environments, the user's email addresses (for example, “username1@email.com” and “username2@anotheremail.com”), zip codes associated with the user's addresses (for example, the user's address in the past 2 years), the user's phone numbers (for example, the user's work phone and home phone numbers), and the like. The request may be in an XML format, although other formats such as, for example, txt or HTML are also possible.

In block 304, the gateway receives a data packet storing the user credentials. In some embodiments, the gateway may first verify that the request is coming from a valid, trusted application. After the request is confirmed to be from a valid and trusted application, the gateway generates an encrypted message including portions of the user identity information to send to one or more of the security and access management platforms. Some example security and access management platforms include identity and access management platforms such as for example Okta, Centify, Microsoft Azure, RSA SecurID, OneLogin, LDAP, and the like.

The security and access management platform(s) process the user credentials to determine whether the user credentials are valid, and send a response back to the gateway.

In block 306, the gateway receives the one or more response(s) from the security and access management platform(s).

At block 308, the gateway determines if the security and access management platform(s) have verified the user credentials.

If the credentials were not validated, then, in block 310, the gateway generates and sends an encrypted data packet to the requesting user at the third party computing system denying authentication of the third party. In various scenarios, the third party environment may have rules regarding the number of attempts for authentication requests. Depending on such rules, the requesting user may then attempt to provide other credentials, and the flow may restart at block 302. Otherwise, the flow may end at block 310.

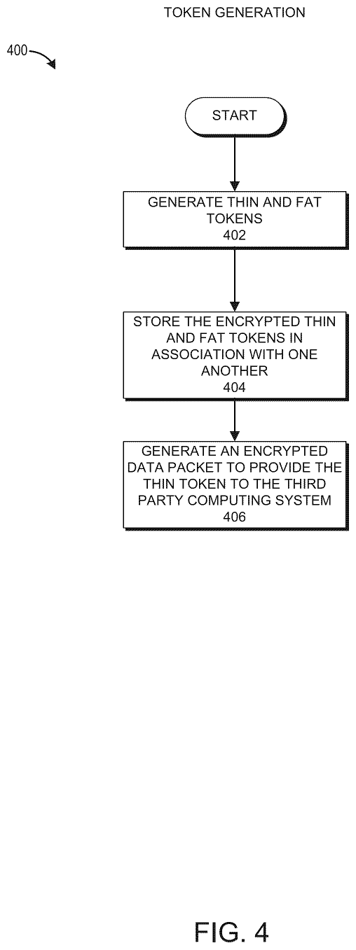

If the credentials were validated by the security and access management platform(s), then, in block 312, the gateway initiates the generation of tokens. One example embodiment of a process for token generation is shown in FIG. 4, and described in detail below.

### B. Token Generation Process

FIG. 4 is a block diagram illustrating an embodiment of a process for token generation.

In some embodiments, the example process for token generation illustrated in FIG. 4 may be performed after the example process for token generation initiation illustrated in FIG. 3 is performed.

Following validation of credentials by one or more of the security and access management platforms, in block 402, the gateway generates a thin token and one or more fat tokens. As described above, the thin token includes a minimal or smaller set of information to send to the resource provider systems 171 to indicate that the user has been validated. The fat token may include additional details which are internal and specific to the protected resources.

After the tokens are generated, in block 404, the gateway stores the thin token and one or more fat tokens in association with one another. As described above, in one embodiment, the thin token is a key which points to the appropriate location in the cache where the associated fat token is stored. In various embodiments, for data security purposes, one or more of encoding, encryption, hashing, salting, and the like may be applied to the tokens.

In block 406, the gateway generates an encrypted data packet to provide the thin token to the third party computing system.

### C. Access Authorization to Protected Resources Process

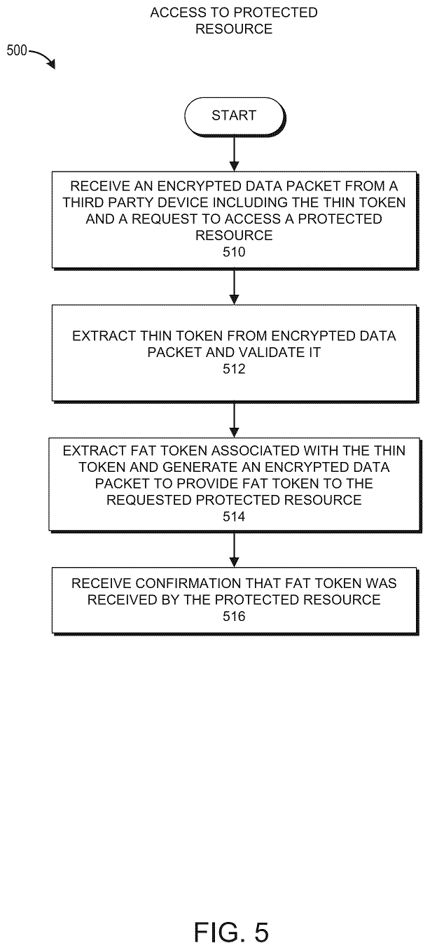

FIG. 5 is a block diagram illustrating an embodiment of a process for access authorization to protected resources.

In block 510, the gateway receives an encrypted data packet from a third party computing system including a thin token and a request to access a protected resource. In some embodiments, block 510 may immediately follow block 406. In other embodiments, block 510 may occur sometime after block 406 is completed.

In block 512, the gateway extracts the thin token from the encrypted data packet received, and validates the thin token. In some embodiments, the extraction may be done using a JavaScript policy. Example details of an embodiment of the structure are provided in more detail below. The validation may include making sure that the thin token is signed, verified, its claims are not null, and that it has not expired.

After the thin token is validated, in block 514, the gateway accesses the fat token associated with the thin token, and generates an encrypted data packet to provide the fat token to the requested protected resource. In some embodiments, this accessing of the fat token includes extracting the JTI claim (described below) from the thin token. As described above, the fat token may include product information and other user information regarding, and used by, the resource provider systems 171 to provide the protected resource(s).

In block 516, the gateway receives confirmation that the fat token was received by the resource provider systems 171.

### V. Token Headers and Data Structures

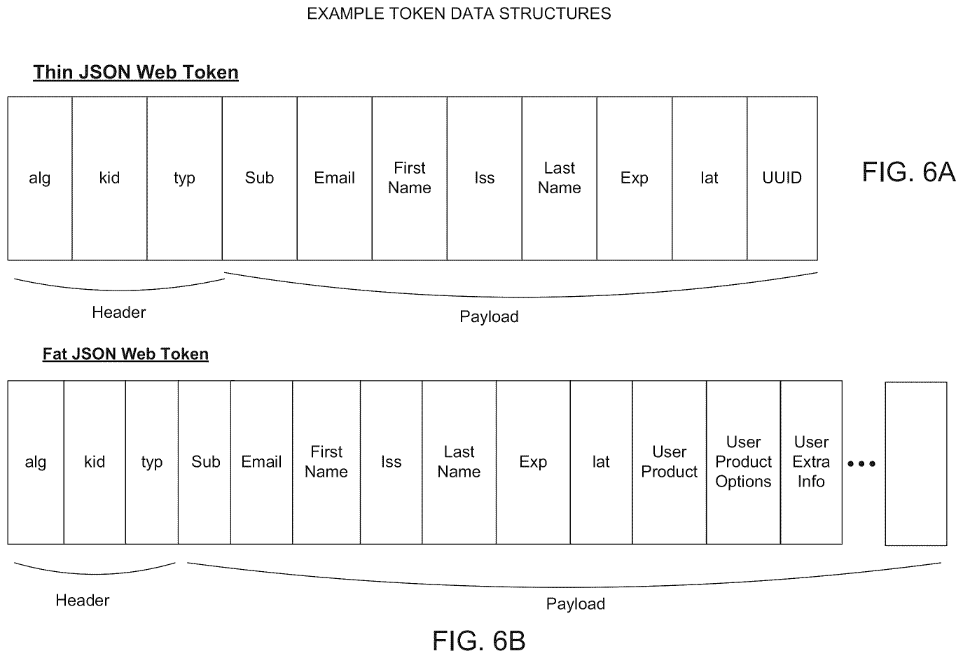

FIGS. 6A and 6B are block diagrams illustrating embodiments of token data structures.

### A. Thin Token

FIG. 6A is a block diagram illustrating an example embodiment of a thin token data structure.

The following table provides more details about the data included in the header of the example embodiment of the thin token structure illustrated in FIG. 6A:

| Property | Description | Datatype | Example |
|---|---|---|---|
| alg | Identifies the | String | “RS256” |
| | digital signature | | |
| | used | | |
| kid | Identifies the | String | “AJjS1rPB7I80GZ82nclJVOBAwWpwe5XhjaSJeGRdwipF1” |
| | public-key used | | |
| | to verify the | | |
| | access_token. | | |
| typ | Type for the | String | “JWT” |
| | token, defaulted | | |
| | to “JWT”. | | |
| | Specifies that this | | |
| | is a JWT token | | |

The following table provides more details about the data included in the payload of the example embodiment of the thin token structure illustrated in FIG. 6A:

| Property | Description | Datatype | Example |
|---|---|---|---|
| Sub | Username in | String | “abc@xyz.com” |
| | security and | | |
| | access | | |
| | management | | |
| | platform | | |
| Email | Email id of the user | String | “abc@xyz.com” |
| FirstName | First name of the user | String | “John” |
| Iss | Issuer of the token | String | “Credit Data Provider” |
| LastName | Last name of the | String | “Doe” |
| | user | | |
| Exp | The time at which | Integer | “1500462376” |
| | the access token | | |
| | expires, in Unix | | |
| | time (seconds) | | |
| Iat | The time at which | Integer | “1500455176” |
| | the token was | | |
| | issued in Unix | | |
| | time (seconds) | | |
| jti | Unique identifier | String | “d277ff94-4c9f-4dcb-a4ad- |
| | for the access | | 59b56fbe41f0” |
| | token. This is a | | |
| | Unique User | | |
| | Identifier (“UUID”). | | |

The identifier value may be assigned in a manner that ensures that there is a negligible probability that the same value will be accidentally assigned to a different data object.

### B. Fat Token

FIG. 6B is a block diagram illustrating an example embodiment of a fat token data structure.

The following table provides more details about the data included in the header of the example embodiment of the fat token structure illustrated in FIG. 6B:

| Property | Description | Datatype | Example |
|---|---|---|---|
| alg | Identifies the digital | String | “RS256” |
| | signature used | | |
| kid | Identifies the public- | String | “AJjS1rPB7I80GZ82nclJVOBAwWpwe5XhjaSJeGRdwipF1” |
| | key used to verify | | |
| | the access_token. | | |
| typ | Type for the token, | string | “JWT” |
| | defaulted to “JWT”. | | |
| | Specifies that this is | | |
| | a JWT token. | | |

The following table provides more details about the data included in the payload of the example embodiment of the fat token structure illustrated in FIG. 6B:

| Property | Description | Datatype | Example |
|---|---|---|---|
| Sub | The username in security | String | “abc@xyz.com” |
| | and access management | | |
| | platform | | |
| Email | Email id of the user | String | “abc@xyz.com” |
| FirstName | The first name of the user | String | “John” |
| Iss | Issuer of the token | String | “Credit Data Provider” |
| LastName | The last name of the user | string | “Doe” |
| Exp | The time at which the access | Integer | “1500462376” |
| | token expires, this is in Unix | | |
| | time (seconds) | | |
| Iat | The time at which the token | Integer | “1500455176” |
| | was issued in Unix time | | |
| | (seconds) | | |
| UserProduct | The product name in security | String | “Developer Portal non-prod” |
| | and access management | | |
| | platform | | |
| UserProduct | These are the product | JSON | “UserProductOptions”: |
| Options | options associated with the | Array | {“ProductOption”: |
| | product in the UserProduct | | [ |
| | claim | | {“Name”:“CEMS MARS User |
| | | | ID”,“value”:“experian”}, |
| | | | {“Name”:“CEMS Account |
| | | | Number”,“value”:“”}, |
| | | | {“Name”:“CEMS MARS |
| | | | Password”,“value”:“experian”}, |
| | | | {“Name”:“CEMS Client ID”,“value”:“”}, |
| | | | {“Name”:“CEMS Source IP”,“value”:“”} |
| | | | ]} |
| UserExtraInfo | Any custom information | JSON | |
| | requested by the users and | Array | |
| | administrators of the | | |
| | protected resources | | |

It is recognized that the user information may include user information from one or more security and access management systems. In other embodiments, there may be multiple fat tokens associated with each thin token.

### C. Token Headers

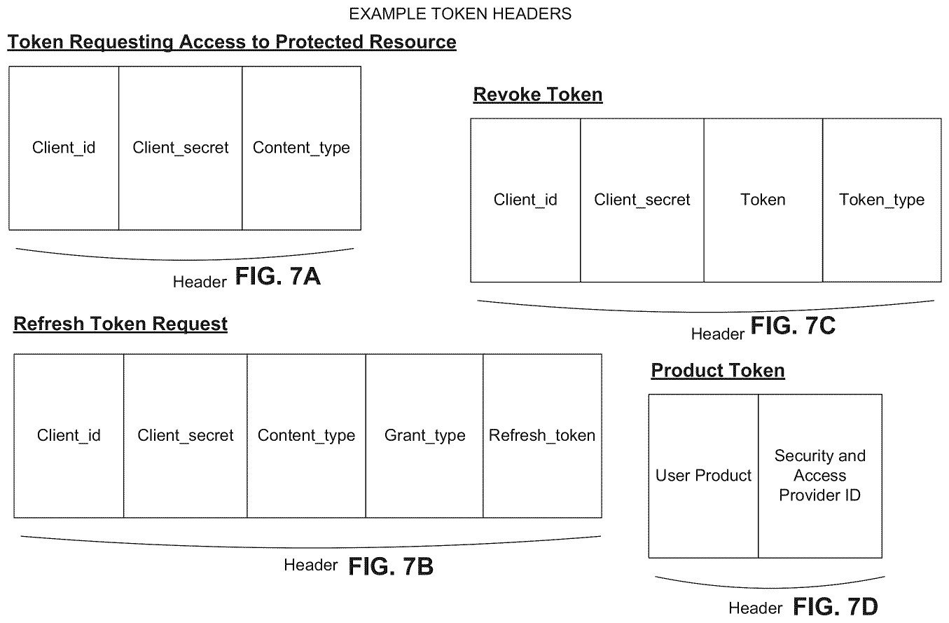

FIGS. 7A, 7B, 7C and 7D are block diagrams illustrating embodiments of token headers.

### 1. Thin Token

FIG. 7A is a block diagram illustrating an embodiment of parameters of a header used in the process of a requesting user at a third party sending a request to access a protected resource after having received a thin token from the gateway. As seen in FIG. 7A, the header includes a parameter Client_id, a string which provides the client identification, a parameter Client_secret, a string which provides the client secret, which may in some examples be an encrypted key, and a parameter Content_type, a string which provides the payload type, such as for example JSON. In some embodiments, the payload may include the requesting user's username and password, for example.

The response sent back from the gateway to the requesting user may include an indication of the time the token has issued, time at which it will expire, the type of token, and finally the issuer of the token.

### 2. Refresh Process

FIG. 7B is a block diagram illustrating an embodiment of parameters of a header used in a refresh process of a third party user obtaining an updated thin token or a new access token.

As seen in FIG. 7B, the header includes the parameters Client_id, Client_secret and Content_type, which are similar to the parameters described above in FIG. 7A. In addition, the header for a refresh request additionally includes a parameter Grant_type, which is a string with the value “refresh_token” for example. Finally, the header also includes a parameter Refresh_token, which is the fresh token received by the gateway.

The process for the refresh would involve the third party user sending the refresh token request to the gateway, the gateway validating the Client_id and Client_secret, generating a refresh thin token (which could be the same token as previously generated but with updated parameters for the expiry time, for example), caching the refresh token in association with the previously generated fat token, and sending the refreshed token back to the third party user.

In some embodiments, the refresh token process may only refresh active thin tokens but could also update one or more fat tokens. For example, after being generated, the thin tokens may generally expire in 24 hours; however, a given thin token may only be active for 30 minutes. Thus, the refresh process may only refresh the thin token in those 30 minutes. However, the fat token may be refreshed after the 24 hours, when the thin token expires or it may be deleted entirely such that a new fat token may be generated using any security and access management environment 104A/104B updated information when the next thin token is generated.

### 3. Revoke Process

FIG. 7C is a block diagram illustrating an embodiment of parameters of a header used in the process of revoking a third party user's thin token (original or refreshed).

This process may be invoked, for example, when the third party user needs to log out of a given application, or out of their computing system. The third party may be an individual working at an organization, and the organization's administrator may also decide to log the individual out. For example, the third party administrator may wish to cut off access to protected resources for a terminated employee. In another example, the administrator may wish to end access for the entire organization.

As seen in FIG. 7C, the header includes the parameters Client_id and Client_secret, which are similar to the parameters described above in FIG. 7A. In addition, the header for a revoke token additionally includes a parameter Token, which identifies which token should be revoked, such as a unique identifier for the token such as the UUID. The identifier value may be assigned in a manner that ensures that there is a negligible probability that the same value will be accidentally assigned to a different data object. Finally, the header also includes a parameter Token_type, which is a string that has values of original, refresh, or JTI, for example.

When a requesting user decides to, or is made to log out, which would signal that the third party user hits the endpoint of their token valid time, the gateway again validates the Client_id and Client_secret. Then, depending on whether the token type is original or refresh, the gateway revokes the appropriate token only. At the same time, the gateway creates a new cache called for example “blacklistToken_Cache,” which would persist the blacklisted token. The expiry time of the cache will be the same as the refresh token expiry time. If the token type is JTI, then the gateway revokes all original and refresh tokens, or JTI tokens. This may cause the third party to be entirely logged out of an application, for example.

In various embodiments, the revoke process may be invoked by a specific application on a third party user computing system, in which case the revocation of the thin token would cause the user to be logged out of the specific applications. In other embodiments, the administrator of the third party environment may wish to revoke thin tokens for all users at once such as for example revoking all tokens with a specific client identifier—and the revoke process may be used for that as well.

### 4. Product Token

FIG. 7D is a block diagram illustrating an embodiment of parameters of a header of a product token.

The illustrated token includes a product identifier such as a name or unique ID and then an indication of which security and access management provider handles the user authentication for the product.

### VI. Example Applications

In one example, an employee of Bank X wants to get credit report of consumer Y. The employee of Bank X also wants to get a fraud score for consumer Y. The employee tries to log in to Bank X's application providing credit reports and fraud score from the employee's tablet using a username and password. Gateway 170 receives from the employee of Bank X the employee's username and password, along with a request for these two types of resources.

Gateway 170 then determines the employee's security information, and then contacts security and access management environment 104A to determine if the employee of Bank X is authenticated and has correct privilege for accessing a credit report of consumer Y. Gateway 170 also contacts security and access management environment 104B to determine if the employee of Bank X is authenticated and has correct privilege for getting a fraud score for consumer Y.

After security and access management environment 104A and security and access management environment 104B confirm that the employee of Bank X is authenticated to access both credit reports and fraud scores regarding consumer Y, then gateway 170 creates a single thin token for the employee, and a fat token for each of the employee's requests (credit report for consumer Y and fraud score for consumer Y) using data from the security and access management environment 104A and security and access management environment 104B. The gateway also stores the thin token in association with the two fat tokens in the token repository in a key-value cache scheme. Though in other embodiments, the fat token includes data from both security and access management environment 104A and security and access management environment 104B.

Then the gateway 170 sends the thin token back to the employee's tablet. Then, the employee sends a request for accessing the resources back to the gateway 170, after which, the gateway 170 validates the thin token and then retrieves the appropriate fat tokens associated with it, and forwards the fat tokens (which include private data from the security and access management environment 104A and security and access management environment 104B) to the resource provider systems 171, in this case, a credit report provider system, and a fraud analytics provider system. The resource provider systems then send confirmation of receipt to the gateway.

### VII. Example System Implementation and Architecture

In some embodiments, any of the systems, servers, or components referenced herein including the token provider repository system 130, the gateway 170, the computing systems 146A, 146B, 164A, 164B, the resource provider systems 171 may take the form of a computing system as shown in FIG. 8 which illustrates a block diagram of an embodiment of a computing device 800. The computing device 800 may include, for example, one or more personal computers that is IBM, Macintosh, or Linux/Unix compatible or a server or workstation. In one embodiment, the computing device 800 comprises a server, a laptop computer, a smart phone, a personal digital assistant, a tablet, or a desktop computer, for example. In one embodiment, the illustrated computing device 800 includes one or more central processing unit (CPU) 802, which may each include a conventional or proprietary microprocessor. The computing device 800 further includes one or more memory 806, such as random access memory (RAM) for temporary storage of information, one or more read only memory (ROM) for permanent storage of information, and one or more mass storage device 810, such as a hard drive, diskette, solid state drive, or optical media storage device. The computing device 800 may also include a token module 808 which performs one or more of the processed discussed herein. Typically, the components of the computing device 800 are connected to the computer using a standard based bus system. In different embodiments, the standard based bus system could be implemented in Peripheral Component Interconnect (PCI), Microchannel, Small Computer System Interface (SCSI), Industrial Standard Architecture (ISA) and Extended ISA (EISA) architectures, for example. In addition, the functionality provided for in the components and modules of computing device 800 may be combined into fewer components and modules or further separated into additional components and modules.

The computing device 800 is generally controlled and coordinated by operating system software, such as Windows XP, Windows Vista, Windows 7, Windows 8, Windows 10, Windows Server, Unix, Linux, SunOS, Solaris, Blackberry OS, or other compatible operating systems. In Macintosh systems, the operating system may be any available operating system, such as iOS or MAC OS X. In other embodiments, the computing device 800 may be controlled by a proprietary operating system. Conventional operating systems control and schedule computer processes for execution, perform memory management, provide file system, networking, I/O services, and provide a user interface, such as a graphical user interface (GUI), among other things.

The illustrated computing device 800 may include one or more commonly available input/output (I/O) devices and interfaces 804, such as a keyboard, mouse, touchpad, and printer. In one embodiment, the I/O devices and interfaces 804 include one or more display devices, such as a monitor, that allows the visual presentation of data to a user. More particularly, a display device provides for the presentation of GUIs, application software data, reports, benchmarking data, metrics, and/or multimedia presentations, for example. The computing device 800 may also include one or more multimedia devices 812, such as speakers, video cards, graphics accelerators, and microphones, for example.

In the embodiment of FIG. 8, the I/O devices and interfaces 804 provide a communication interface to various external devices. In the embodiment of FIG. 8, the computing device 800 is electronically coupled to one or more networks, which comprise one or more of a LAN, WAN, and/or the Internet, for example, via a wired, wireless, or combination of wired and wireless, communication link. The networks communicate with various computing devices and/or other electronic devices via wired or wireless communication links, such as the ERP data sources.

In some embodiments, information may be provided to the computing device 800 over a network from one or more data sources. The data sources may include one or more internal and/or external data sources. In some embodiments, one or more of the databases or data sources may be implemented using a relational database, such as Sybase, Oracle, CodeBase, PostgreSQL, and Microsoft® SQL Server as well as other types of databases such as, for example, a flat file database, an entity-relationship database, an object-oriented database, a non-relational database, and/or a record-based database.

In general, the word “module,” as used herein, refers to logic embodied in hardware or firmware, or to a collection of software instructions, possibly having entry and exit points, written in a programming language, such as, for example, Java, Lua, C, C #, or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing device 800, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In the example of FIG. 8, the modules 808 and 814 may be configured for execution by the CPU 802 to perform any or all of the processes discussed herein. Depending on the embodiment, certain processes, or in the processes, or groups of processes discussed herein may be performed by multiple devices, such as multiple computing systems similar to computing device 800.

### VIII. Additional Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

As used herein, the terms “determine” or “determining” encompass a wide variety of actions. For example, “determining” may include calculating, computing, processing, deriving, generating, obtaining, looking up (for example, looking up in a table, a database or another data structure), ascertaining and the like via a hardware element without user intervention. Also, “determining” may include receiving (for example, receiving information), accessing (for example, accessing data in a memory) and the like via a hardware element without user intervention. Also, “determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the recipient via at least one wired or wireless communication medium, transmitting or storing a reference to a value, and the like. “Providing” may also include encoding, decoding, encrypting, decrypting, validating, verifying, and the like via a hardware element.

As used herein, the term “message” encompasses a wide variety of formats for communicating (for example, transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein “receive” or “receiving” may include specific algorithms for obtaining information. For example, receiving may include transmitting a request message for the information. The request message may be transmitted via a network as described above. The request message may be transmitted according to one or more well-defined, machine readable standards which are known in the art. The request message may be stateful in which case the requesting device and the device to which the request was transmitted maintain a state between requests. The request message may be a stateless request in which case the state information for the request is contained within the messages exchanged between the requesting device and the device serving the request. One example of such state information includes a unique token that can be generated by either the requesting or serving device and included in messages exchanged. For example, the response message may include the state information to indicate what request message caused the serving device to transmit the response message.

As used herein “generate” or “generating” may include specific algorithms for creating information based on or using other input information. Generating may include retrieving the input information such as from memory or as provided input parameters to the hardware performing the generating. Once obtained, the generating may include combining the input information. The combination may be performed through specific circuitry configured to provide an output indicating the result of the generating. The combination may be dynamically performed such as through dynamic selection of execution paths based on, for example, the input information, device operational characteristics (for example, hardware resources available, power level, power source, memory levels, network connectivity, bandwidth, and the like). Generating may also include storing the generated information in a memory location. The memory location may be identified as part of the request message that initiates the generating. In some implementations, the generating may return location information identifying where the generated information can be accessed. The location information may include a memory location, network locate, file system location, or the like.

As used herein, “activate” or “activating” may refer to causing or triggering a mechanical, electronic, or electro-mechanical state change to a device. Activation of a device may cause the device, or a feature associated therewith, to change from a first state to a second state. In some implementations, activation may include changing a characteristic from a first state to a second state such as, for example, changing the viewing state of a lens of stereoscopic viewing glasses. Activating may include generating a control message indicating the desired state change and providing the control message to the device to cause the device to change state.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the computing system and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

1-20. (canceled)

21. A system for providing tokens to facilitate authentication and access to protected resources, the system comprising:
a token gateway computing system, wherein the token gateway computing system is configured to:
receive, from a user computing system, a first data packet including user credentials of a user and a request for an authentication token to access one or more protected resources from a protected resource computing system;
transmit a second data packet to a first access management computing system;
receive, from the first access management computing system, validation of the user, and private data;
generate a first token;
generate a second token using the private data, wherein the second token comprises a first portion of the first token and additional data;
transmit the first token to the user computing system;
receive, from the user computing system, a request to access the one or more protected resources from the protected resource computing system, the request comprising the first token;
validate the received first token; and
transmit the second token to the protected resource computing system.

22. The system of claim 21, wherein the first token and the second token are based on a JavaScript Object Notation (JSON) web token standard.

23. The system of claim 21, wherein the token gateway computing system is further configured to transmit the second data packet based on a type associated with the one or more protected resources requested.

24. The system of claim 21, wherein the first token is a thin token and the second token is a fat token.

25. The system of claim 21, wherein the first portion of the first token comprises a payload.

26. The system of claim 21, wherein the first token and second token headers each include a public key and a type associated with the token.

27. The system of claim 21, wherein the first portion of the first token includes at least a username, an email, a first name, an issuer of the first token, a last name, an expiry time, an issue time, and a unique identifier.

28. The system of claim 21, wherein the additional data in the second token include details regarding the protected resources.

29. The system of claim 28, wherein the additional data includes:
a product name of a protected resource as identified in the first access management computing system;
product options associated with the product name; and
additional custom information requested by users and administrators of the protected resource computing system.

30. A computer-implemented method for providing tokens to facilitate authentication and access to protected resources, the computer-implemented method comprising, as implemented by one or more computing devices within a token gateway system configured with specific executable instructions:
receiving, from a user computing system, a first data packet including user credentials of a user and a request for an authentication token to access one or more protected resources from a protected resource computing system;
transmitting a second data packet to a first access management computing system;
receiving, from the first access management computing system, validation of the user, and private data;
generating a first token;
generating a second token using the private data, wherein the second token comprises a first portion of the first token and additional data;
transmitting the first token to the user computing system;
receiving, from the user computing system, a request to access the one or more protected resources from the protected resource computing system, the request comprising the first token;
validating the received first token; and
transmitting the second token to the protected resource computing system.

31. The computer-implemented method of claim 30, wherein the first token and the second token are based on a JavaScript Object Notation (JSON) web token standard.

32. The computer-implemented method of claim 30, wherein the token gateway system is further configured to transmit the second data packet based on a type associated with the one or more protected resources requested.

33. The computer-implemented method of claim 30, wherein the first token is a thin token and the second token is a fat token.

34. The computer-implemented method of claim 30, wherein the first portion of the first token comprises a payload.

35. The computer-implemented method of claim 30, wherein the first token and second token headers each include a public key and a type associated with the token.

36. The computer-implemented method of claim 30, wherein the first portion of the first token includes at least a username, an email, a first name, an issuer of the first token, a last name, an expiry time, an issue time, and a unique identifier.

37. The computer-implemented method of claim 30, wherein the additional data in the second token include details regarding the protected resources.

38. The computer-implemented method of claim 37, wherein the additional data includes:
a product name of a protected resource as identified in the first access management computing system;
product options associated with the product name; and
additional custom information requested by users and administrators of the protected resource computing system.

39. A non-transitory computer storage medium storing computer-executable instructions that, when executed by a processor, cause the processor to at least:
receive, from a user computing system, a first data packet including user credentials of a user and a request for an authentication token to access one or more protected resources from a protected resource computing system;
transmit a second data packet to a first access management computing system;
receive, from the first access management computing system, validation of the user, and private data;
generate a first token;
generate a second token using the private data, wherein the second token comprises a first portion of the first token and additional data;
transmit the first token to the user computing system;
receive, from the user computing system, a request to access the one or more protected resources from the protected resource computing system, the request comprising the first token;
validate the received first token; and
transmit the second token to the protected resource computing system.

40. The non-transitory computer storage medium of claim 39, wherein the first token includes a key pointing to the second token.
